(19) United States
(12) Patent Application Publication
(10) Pub. No.: US 2009/0108152 A1
(43) Pub. Date: Apr. 30, 2009

(54) Suction cup mounting platform

(76) Inventor: Jeffrey D. Carnevali, Seattle, WA (US)

Correspondence Address: CHARLES J RUPNICK, PO BOX 46752, SEATTLE, WA, 98146, US

(21) Appl. No.: 11/977,812

(22) Filed: Oct. 26, 2007

(51) Int. Cl. F16B 47/00

(52) U.S. Cl. 248/205.5

(57) ABSTRACT

A suction cup mounting platform formed of a substantially rigid plate having first and second opposing faces; a suction cup mounting surface formed on the first face; and a connector interface formed adjacent to the second face.

### FIELD OF THE INVENTION

The present invention relates generally to mounting platforms for attachment of suction cups, and in particular to universal vehicle mountable suction cup attachment platforms structured for compatibility with custom vehicle specific mounts designed for mounting cradles designed for handheld accessories.

### BACKGROUND OF THE INVENTION

Suction cup mounting devices are generally well-known for mounting various handheld electronic devices for hands-free operation, particularly in automobiles and other vehicles. However, the only smooth and flat surface available for mounting suction cups in many vehicles are the front or side windscreens. As a result, suction cup mounting devices are being replaced by custom vehicle specific mounts (VSM) for installing a wide range of handheld devices in cars, trucks, vans and sport utility vehicles (SUV's). Such VSM's are designed by various US manufacturers to blend into the vehicle's interior with a professional fit and factory-like appearance. Such VSM's are designed to use existing dash fittings behind the trim so that alterations to the vehicle's interior are eliminated. They are ergonomically designed for hands-free operation so the driver can keep eyes on the road, while positioning the electronic device within easy reach and operation. Such VSM's are custom designed for nearly every popular vehicle on the road.

VSM's feature a standard AMPS hole pattern for mounting cradles designed for popular handheld accessories, e.g., XM Satellite radios, holders, phone and personal digital assistant (PDA) or iPod interfaces, et cetera. They feature optimum vehicle mounting location so as to maximize safety for both the driver and the passengers. When properly installed VSM's are virtually unseen. They have no movable parts and custom bends so that no adjustments are required to perfect installation. Additionally, they install easily behind the dash bezel, often using existing original hardware, but they do not block airbags, nor obstruct dash amenities or controls. VSM's provide a rock solid mounting platform for the most popular handheld accessories.

However, known VSM's are limited precisely because they feature the standard AMPS hole pattern, which is a common hole pattern adopted by most electronics manufacturers for mounting their devices. Such hole patterns in their ability to provide a quick and easy way to move the handheld mount between vehicles since it must be connected to the AMPS hole pattern with fasteners.

### SUMMARY OF THE INVENTION

The present invention is a novel suction cup mounting platform compatible with vehicle specific mounts (VSM) as well as other vehicle mounts.

According to one aspect of the invention the novel suction cup mounting platform is a simple plate structured on one side with a hole pattern compatible with the standard AMPS hole pattern used for VSM's, and structured on an opposite side with a substantially smooth and planar mounting plane.

According to another aspect of the invention, a method is taught for providing mounting of a suction cup in a vehicle, the method including: within an interior of a vehicle, providing an accessory vehicle mounting platform comprising a first predetermined hole pattern substantially exposed relative to an interior portion of the vehicle; providing a monolithic plate having first and second opposing faces, the first face comprising a suction cup mounting surface formed thereon; and connecting the second face of the monolithic plate to the accessory vehicle mounting platform with the first face thereof facing away therefrom.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view showing an operational example of the present invention illustrated by example and without limitation as a novel suction cup mounting platform formed as a substantially rigid monolithic mounting plate having a suction cup mounting device mounted on a suction cup mounting surface thereof, the novel suction cup mounting platform is illustrated here by example and without limitation as being attached to a accessory vehicle mounting platform by fastening means and mounted within an interior space of a vehicle;

FIG. 2 is a top perspective view that illustrates the novel suction cup mounting platform by example and without limitation as being formed of the substantially rigid monolithic mounting plate formed of an injection moldable material, such as plastic, having a first face thereof being formed with the substantially smooth and planar surface of a type useful as a suction cup mounting surface;

FIG. 3 illustrates a second face of the substantially rigid monolithic mounting plate of the novel suction cup mounting platform as including by example and without limitation the fastening means as being compatible for fastening to a first predetermined hole pattern, for example a standard AMPS hole pattern;

FIG. 4 illustrates the monolithic mounting plate of the novel suction cup mounting platform being attached to the accessory vehicle mounting platform by the fastening means;

FIG. 5 illustrates the monolithic mounting plate of the novel suction cup mounting platform being attached to the accessory vehicle mounting platform in such manner that the suction cup mounting surface formed on the first face thereof is facing away therefrom and being substantially fully exposed for attachment thereto of the suction cup mounting devices;

FIG. 6 is a perspective view showing an operational example of the novel suction cup mounting platform by example and without limitation as being attached to a weighted mounting platform and mounted within an interior space of a vehicle;

FIG. 7 illustrates the novel suction cup mounting platform being attached to the weighted mounting platform with the suction cup mounting device being removed for clarity from the suction cup mounting surface portion of the first face of the mounting plate, as by release of the suction holding it thereto;

FIG. 8 illustrates the novel suction cup mounting platform being attached to the weighted mounting platform having the common central hub thereof being formed with a hole pattern through a base portion thereof, such as the standard AMPS hole pattern;

FIG. 9 is a cross-section view that illustrates by example and without limitation the novel suction cup mounting platform being attached to the weighted mounting platform as discussed herein;

FIG. 10 is another cross-section view that illustrates by example and without limitation the novel suction cup mounting platform being attached to the weighted mounting platform as discussed herein;

FIG. 11 is a perspective view showing an operational example of the novel suction cup mounting platform by example and without limitation as being attached to an interlockable ball-and-socket type swivel mount assembly and mounted within an interior space of a vehicle;

FIG. 12 is another perspective view showing an operational example of the novel suction cup mounting platform by example and without limitation as being attached to an interlockable ball-and-socket type swivel mount assembly and mounted within an interior space of a vehicle; and

FIG. 13 illustrates the novel suction cup mounting platform being attached to either of the accessory vehicle mounting platform or directly to an interior surface of the vehicle, such as the dash or a console utilizing a Pressure Sensitive Adhesive or PSA fastening means.

### DETAILED DESCRIPTION OF PREFERRED EMBODIMENT

In the Figures, like numerals indicate like elements.

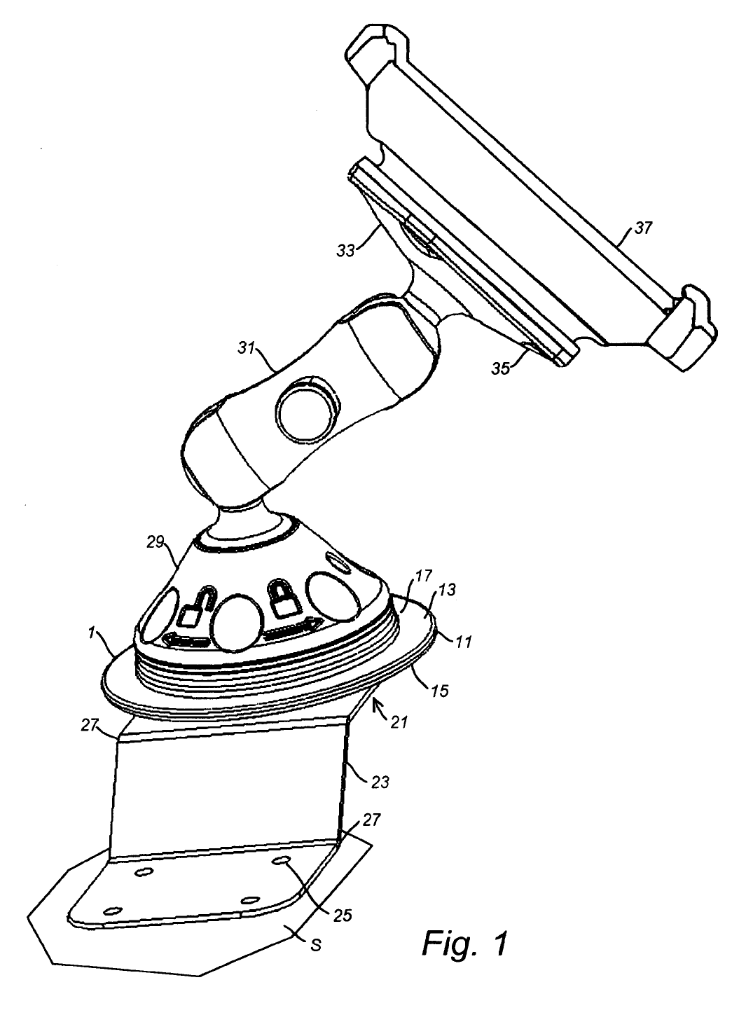

FIG. 1 shows the present invention illustrated by example and without limitation as a suction cup mounting platform 1 formed as a substantially rigid monolithic mounting plate 11 having first and second opposing faces 13 and 15. The first face 13 is formed with a substantially smooth and planar surface 17 of a type useful as a suction cup mounting surface. As illustrated in one or more subsequent Figures, the second face 15 includes a fastening means 19 for fastening to a first predetermined hole pattern 21, for example a standard AMPS hole pattern, which is a common hole pattern adopted by most electronics manufacturers for mounting cradles designed for their handheld electronics accessories. The fastening means 19 is thus compatible with the first predetermined standard AMPS hole pattern 21.

The fastening means 19 is utilized for fastening the mounting plate 11 to an accessory vehicle mounting platform 23 structured for installing a wide range of handheld devices in cars, trucks, vans and sport utility vehicles (SUV's), as is well-known in the art. The vehicle mounting platform 23 is formed with the predetermined hole pattern 21. Here, the accessory vehicle mounting platform 23 is further formed with a second predetermined hole pattern 25 designed to use existing dash fittings behind the trim so that alterations to the vehicle's interior surfaces are eliminated, as is also well-known in the art. The second predetermined hole pattern 25 is spaced away from the first predetermined hole pattern 21 so that the suction cup mounting platform 1 mounted thereon is substantially clear of the dash, including airbags, dash amenities and controls. The accessory vehicle mounting platform 23 is further formed with one or more custom bends 27 so that no adjustments are required to perfect installation in the vehicle. Additionally, the custom bends 27 permit the accessory vehicle mounting platform 23 to be installed easily behind the dash bezel, often using existing original hardware with the second predetermined hole pattern 25, but without blocking airbags, nor obstructing dash amenities or controls. Such accessory vehicle mounting platform 23 thus provide a rock solid mounting platform for mounting cradles to hold the most popular handheld electronics accessories.

Obviously, the first standard AMPS or other hole pattern 21 for mounting cradles for handheld electronics accessories prevents a suction cup device from drawing a vacuum. Therefore, known accessory vehicle mounting platforms 23 are limited to having such accessory cradles permanently secured using mechanical fasteners.

In contrast to known accessory vehicle mounting platforms 23, according to the present invention, after the accessory vehicle mounting platform 23 is installed within the interior of the vehicle, a suction cup mounting device 29 is mounted on the suction cup mounting surface 17 formed on the first face 13 of the mounting plate 11. Such suction cup mounting devices 29 include, but are not limited to, suction cup mounting devices of the type disclosed by the inventor of the present invention in U.S. Pat. No. 6,666,420, “Suction Cup Having Compact Axial Installation And Release Mechanism” issued Dec. 23, 2003, which is incorporated in its entirety herein by reference.

The suction cup mounting device 29 is illustrated here as having a dual ball-and-socket coupler 31, for example, of the well-known type disclosed by the inventor of the present invention in U.S. Pat. No. 5,845,885, “Universally Positionable Mounting Device” issued Dec. 8, 1998, which is incorporated in its entirety herein by reference. The coupler 31 supports another mounting platform 33 having a predetermined hole pattern 35, either a duplicate of the first predetermined standard AMPS hole pattern 21, or another hole pattern compatible with one or more mounting cradles 37 of types designed for receiving different handheld electronics accessories by different manufacturers. Else, the hole pattern 35 is a custom hole pattern compatible with one or more proprietary mounting cradles 37 of types designed for different handheld electronics accessories by a single manufacturer, such as the manufacturer of the present suction cup mounting platform 1. Accordingly, the present invention takes the accessory vehicle mounting platform 23 having the predetermined hole pattern 21 for attaching thereto one or more different mounting cradles 37 for receiving different handheld electronics accessories by different manufacturers and converts it into the suction cup mounting platform 1 having the suction cup mounting surface 17 formed on the first face 13 of the mounting plate 11. Thereafter, the user freely connects and disconnects the suction cup mounting devices 29 to the mounting surface 17 for holding a selected device mounting cradle 37 in a convenient location within the vehicle.

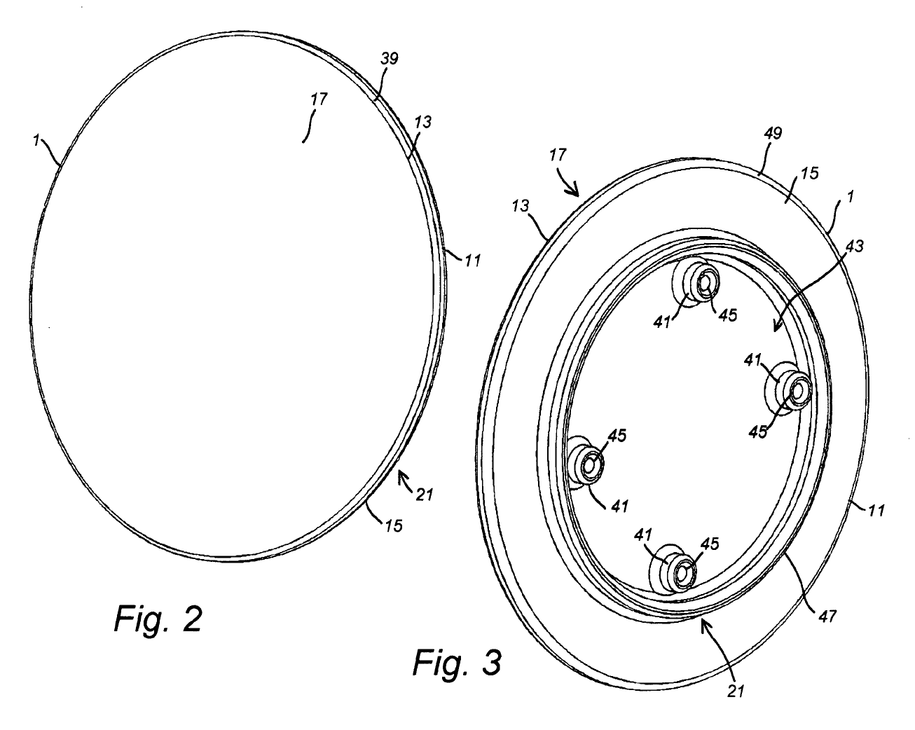

FIG. 2 illustrates the suction cup mounting platform 1 by example and without limitation as being formed of the substantially rigid monolithic mounting plate 11 formed of an injection moldable material, such as plastic, having the first face 13 thereof being formed with the substantially smooth and planar surface 17 of a type useful as a suction cup mounting surface. As illustrated here, the mounting plate 11 is optionally substantially round in shape having the suction cup mounting surface 17 covering substantially the entirety of the first face 13 thereof The face 13 having an optional peripheral edge break 39 to eliminate sharp edges. Alternatively, the suction cup mounting surface 17 covers a portion of the first face 13 less than substantially the entirety thereof The mounting plate 11 optionally may be another shape than substantially round; for example, the mounting plate 11 may be substantially square or polygonal without deviating from the scope and intent of the present invention.

FIG. 3 illustrates the second face 15 of the substantially rigid monolithic mounting plate 11, which by example and without limitation includes the fastening means 19 for fastening to the first predetermined hole pattern 21, for example the standard AMPS hole pattern. The fastening means 19 is thus compatible with the first predetermined standard AMPS hole pattern 21. Here, by example and without limitation, the fastening means 19 is provided as a plurality of bosses 41 raised on the second face 15, each of the bosses 41 being arranged in a pattern 43 that is compatible with the standard AMPS hole pattern used for the accessory vehicle mounting platform 23.

By example and without limitation, the bosses 41 are provided with a fastener receptor hole 45 substantially perpendicular to the second face 15, but that does not pierce the mounting plate 11. The receptor holes 45 are optionally formed with screw threads for receiving a threaded fastener, or are optionally smooth bore suitable for receiving a self-tapping screw fastener. Other fastening means 19 are also contemplated and may be substituted without deviating from the scope and intent of the present invention. For example, the fastening means 19 is optionally a plurality of threaded studs arranged in the pattern 43 that is compatible with the standard AMPS hole pattern 21 used for the accessory vehicle mounting platform 23.

Optionally, the second face 15 of the substantially rigid monolithic mounting plate 11 further includes a stiffener structure 47. By example and without limitation, the optional stiffener structure 47 is integrally formed with the monolithic mounting plate 11 as an intermittent or continuous (shown) substantially circular hoop or ridge spaced outboard of the bosses 41 but may be inboard of an outer peripheral edge break 49 of the second face 15, as illustrated here by example and without limitation. As illustrated here, the optional stiffener structure 47 also provides a mounting seat relative to the accessory vehicle mounting platform 23 by being projected away from the second face 15 of the mounting plate 11 farther than the bosses 41 of the fastening means 19. Accordingly, the optional stiffener structure 47, when present, engages the accessory vehicle mounting platform 23 in a ring outside of the fastening means 19 securing the mounting plate 11 thereto.

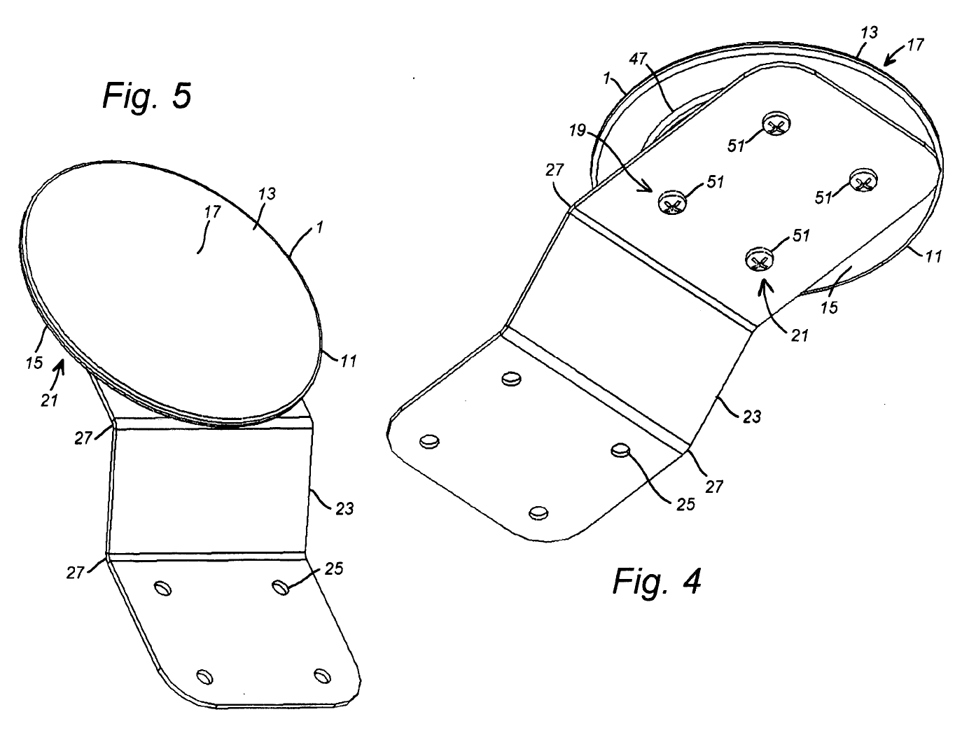

FIG. 4 illustrates the monolithic mounting plate 11 of the suction cup mounting platform 1 being attached to the accessory vehicle mounting platform 23 by the fastening means 19, which is illustrated here by example and without limitation as a plurality of screw-type fasteners 51 inserted through the first predetermined hole pattern 21 in the accessory vehicle mounting platform 23. As illustrated, the monolithic mounting plate 11 of the suction cup mounting platform 1 is sized relative to the accessory vehicle mounting platform 23 such that the second predetermined hole pattern 25 weighted mounting platform 53 using existing dash fittings behind the trim.

FIG. 5 illustrates the monolithic mounting plate 11 of the suction cup mounting platform 1 being attached to the accessory vehicle mounting platform 23 in such manner that the first face 13 is facing away therefrom with the suction cup mounting surface 17 formed thereon being substantially fully exposed for attachment thereto of the suction cup mounting devices 29.

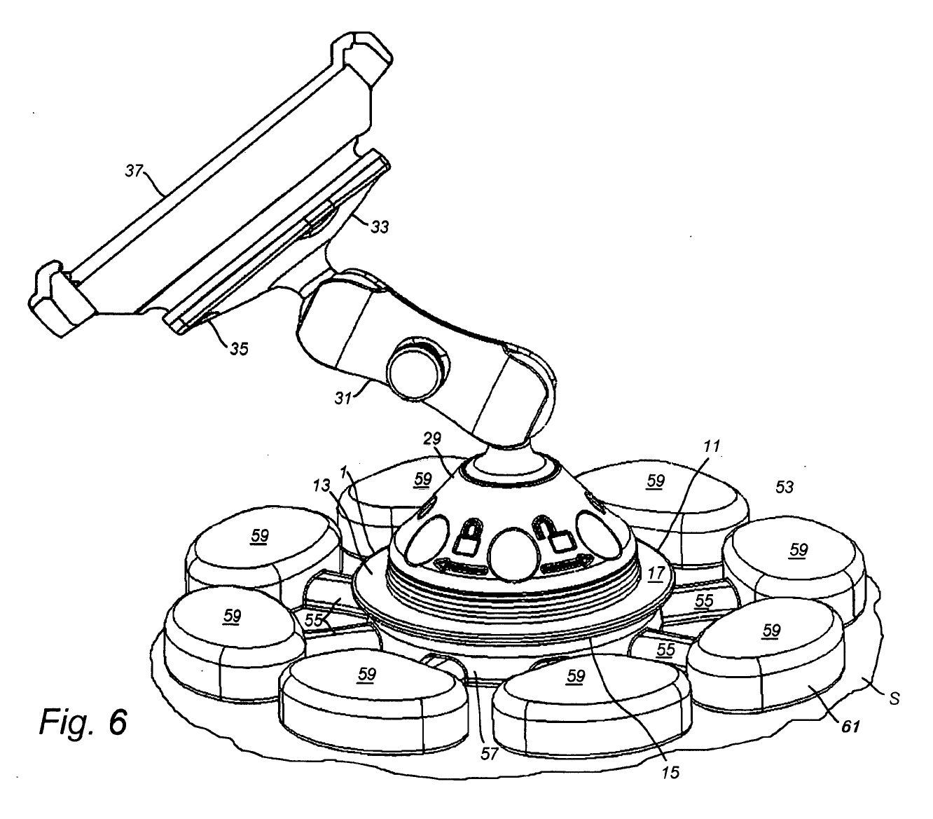

FIG. 6 illustrates the suction cup mounting platform 1 being attached to a weighted mounting platform 53, for example, of the type disclosed by the inventor of the present invention in U.S. Pat. No. 6,840,487, “Weighted Mounting Platform” issued Jan. 11, 2005, which is incorporated in its entirety herein by reference, or in U.S. patent application Ser. No. ______, (Attorney Docket No. NPI-080) “Method For Manufacturing A Weighted Base” filed in the name of the inventor of the present invention, on Oct. 20, 2007, which is incorporated in its entirety herein by reference. Accordingly, the weighted mounting platform 53 is illustrated here as being of the type having a plurality of flexible legs 55 extending radially from a common central hub portion 57, each of the legs 55 having a heavy lump 59 at an end thereof distal from the common central hub 57. A sheath or coating 61 of soft elastomeric material is optionally formed over substantially the entire surface of the flexible legs 55 and the heavy lumps 59, and all or part of the common central hub 57. The monolithic mounting plate 11 of the suction cup mounting platform 1 being attached to the central hub 57 of the weighted mounting platform 53 in such manner that the flexible legs 55 with the heavy lumps 59 at the distal ends thereof are free to drape over an interior surface S of the vehicle, such as the dash or a console or passenger seat. The suction cup mounting platform 1 thus easily supports the suction cup mounting device 29 in an upright manner on the weighted mounting platform 53 with the suction cup mounting device 29 being coupled by suction to the substantially smooth and planar suction cup mounting surface 17 portion of the first face 13 of the mounting plate 11.

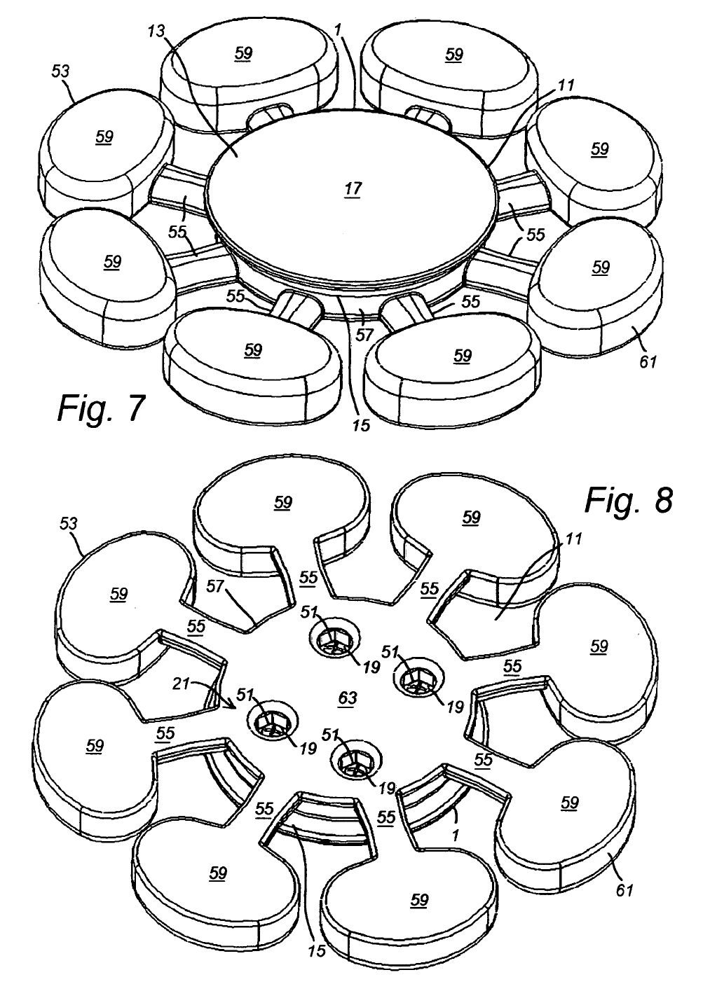

FIG. 7 illustrates the suction cup mounting platform 1 being attached to the weighted mounting platform 53 with the suction cup mounting device 29 being removed for clarity from the suction cup mounting surface 17 portion of the first face 13 of the mounting plate 11, as by release of the suction holding it thereto. As discussed herein, the monolithic mounting plate 11 of the suction cup mounting platform 1 is attached to the central hub 57 of the weighted mounting platform 53 in such manner that the flexible legs 55 with the heavy lumps 59 at the distal ends thereof are free to drape over an interior surface S of the vehicle, such as the dash or a console or passenger seat.

FIG. 8 illustrates the weighted mounting platform 53 with the common central hub 57 thereof being formed with a hole pattern through a base portion 63 thereof, such as the first predetermined standard AMPS hole pattern 21. Accordingly, the suction cup mounting platform 1 is attached to the weighted mounting platform 53 by the fastening means 19, which as discussed herein, is compatible with the first predetermined standard AMPS hole pattern 21.

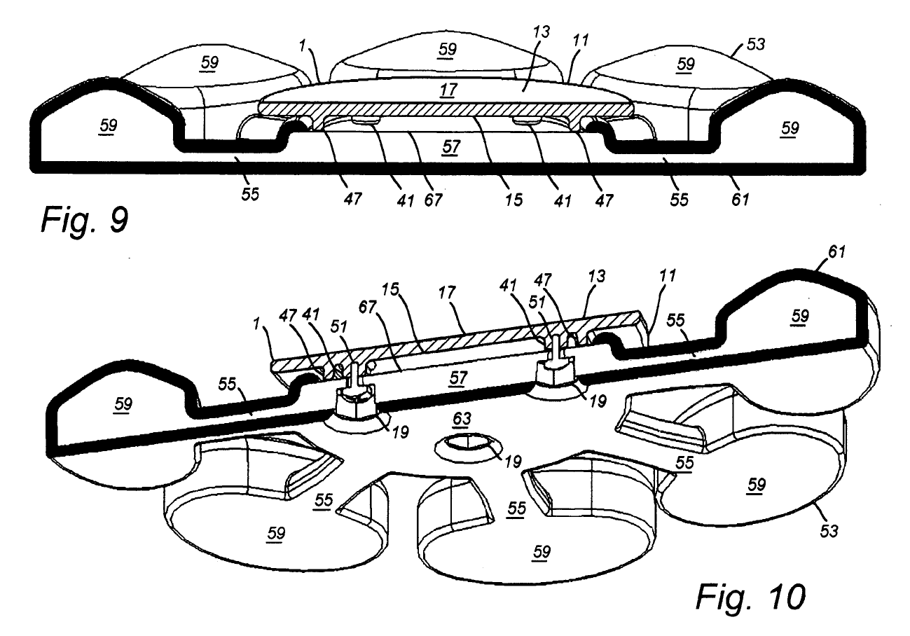

FIG. 9 illustrates the suction cup mounting platform 1 is attached to the weighted mounting platform 53 as discussed herein. The monolithic mounting plate 11 of the suction cup mounting platform 1 is shown herein cross-section, as is the weighted mounting platform 53. As can be seen here, the monolithic mounting plate 11 is structured to fit onto the central hub 57 of the weighted mounting platform 53 without interference with the flexible legs 55 nor with the heavy lumps 59 at the distal ends thereof Furthermore, the optional stiffener structure 47 is integrally formed with the second face 15 of the monolithic mounting plate 11 to fit securely against the central hub 57 of the weighted mounting platform 53. The suction cup mounting platform 1 thus presents the first face 13 of the monolithic mounting plate 11 with the suction cup mounting surface 17 formed thereon being substantially fully exposed for attachment thereto of the suction cup mounting devices 29.

FIG. 10 is another cross-section view of both the weighted mounting platform 53 and the suction cup mounting platform 1 attached thereto. Here, the view is perspective from the base portion 63 of the common central hub 57. This view shows the monolithic mounting plate 11 being secured to the central hub 57 of the weighted mounting platform 53 by the fastening means 19, which as discussed herein, is either threaded screw fasteners received into the receptor holes 45, or threaded studs projected from the second face 15 of the mounting plate 11 and received into the standard AMPS hole pattern 21 used for the accessory vehicle mounting platform 23.

Here, the fastening means 19 is illustrated by example and without limitation as the plurality of screw-type fasteners 51 received into the receptor holes 45 in the bosses 41 projected from the second face 15 of the mounting plate 11. The plurality of screw fasteners 51 are either conventional screw fasteners received into threaded receptor holes 45, or self-tapping screw fasteners received into smooth bore receptor holes 45. Tightening the fastening means 19 snugs the optional integral stiffener structure 47 against a mounting surface 67 of the weighted mounting platform's central hub 57 outboard of the bosses 41, which prevents tipping of the mounting plate 11. After the weighted mounting platform 53 is installed within the interior of the vehicle, the suction cup mounting device 29 is mounted on the suction cup mounting surface 17 formed on the first face 13 of the mounting plate 11, as illustrated herein.

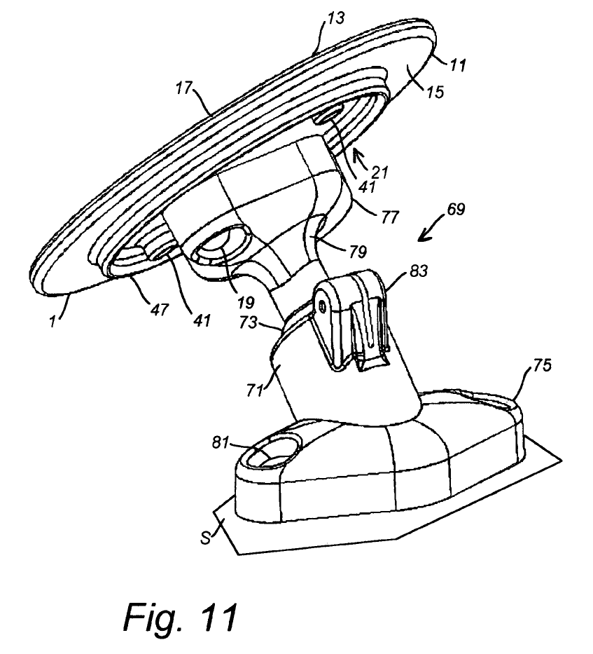

FIG. 11 illustrates the suction cup mounting platform 1 being attached to an interlockable ball-and-socket type swivel mount assembly 69, for example, of the type disclosed by the inventor of the present invention in U.S. Pat. No. 6,561,476, “Positively-Positionable Mounting Apparatus” issued May 13, 2003, which is incorporated in its entirety herein by reference. The swivel mount assembly 69 includes a fixed portion 71 of a ball-and-socket type swivel 73 projected from a first mounting base 75. The swivel mount assembly 69 also includes a second mounting base 77 projected from a swivel portion 79 of the ball-and-socket type swivel 73. One or more fasteners 81 secure the first mounting base 75 to the interior surface S of the vehicle. The fastening means 19 secures the monolithic mounting plate 11 of the suction cup mounting platform 1 to the second mounting base 77. The ball-and-socket type swivel 73 is interlockable by means of a releasable clamp 83 for securing the second mounting base 77 after a desired rotational and angular orientation is achieved for the suction cup mounting surface 17 on the first face 13 of the mounting plate 11. The suction cup mounting device 29 is secured by vacuum to the substantially smooth and planar suction cup mounting surface 17. Thereafter, the swivel mount assembly 69 is operated in a known manner for presenting the suction cup mounting surface 17 and the suction cup mounting device 29 secured thereon in different desired rotational and angular orientations.

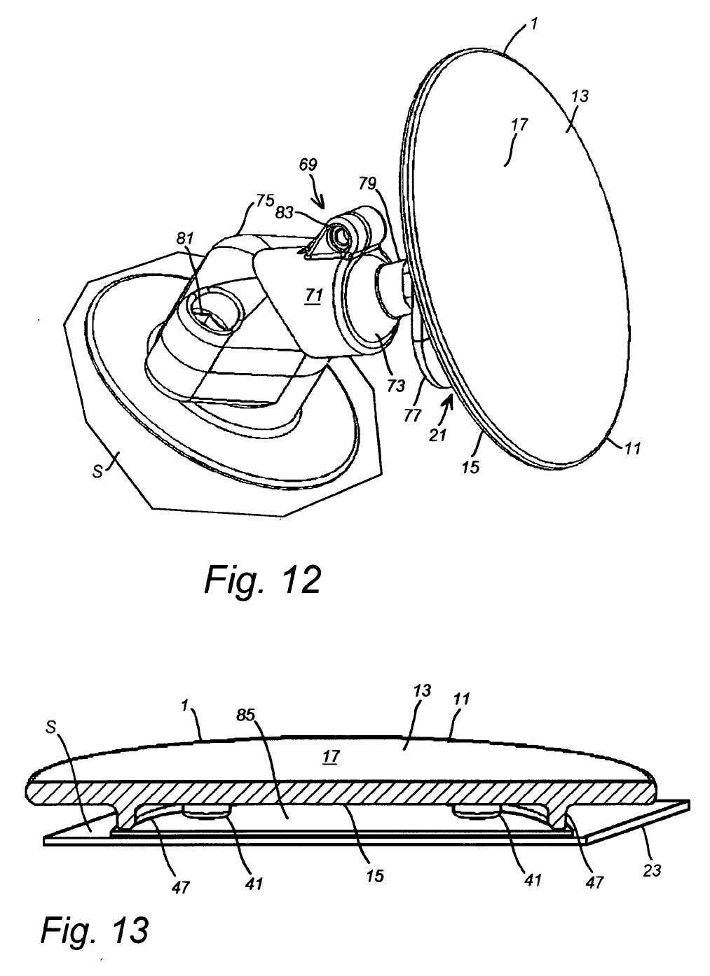

FIG. 12 illustrates the suction cup mounting platform 1 again being attached to the interlockable ball-and-socket type swivel mount assembly 69. Here the swivel mount assembly 69 is attached to the interior surface S of the vehicle by a resilient adhesive pad, commonly known as a Pressure Sensitive Adhesive or PSA 85 applied between the bottom surface of the first mounting base 75 and an interior surface S of the vehicle. Thereafter, the swivel mount assembly 69 is operated in a known manner for presenting the suction cup mounting surface 17 of the mounting plate 11 and the suction cup mounting device 29 secured thereon in different desired rotational and angular orientations.

FIG. 13 illustrates the suction cup mounting platform 1 being attached to either of the accessory vehicle mounting platform 23 or directly to an interior surface S of the vehicle, such as the dash or a console. Here, the fastening means 19 utilizes the PSA 85 in place of the plurality of screw-type fasteners 51 for fastening the second face 15 of the mounting plate 11 to either of the accessory vehicle mounting platform 23 or directly to an interior surface S of the vehicle. For example, the PSA 85 is applied between the bottom surface or second face 15 of the mounting plate 11 directly between the either or both of the bosses 41 and the stiffener structure 47 and either the accessory vehicle mounting platform 23 or an interior surface S of the vehicle. Accordingly, other structures, such as but not limited to the PSA 85, can be substituted for the screw-type fasteners 51 for providing the fastening means 19 without deviating from the scope and intent of the present invention.

When the PSA 85 is utilized as the fastening means 19 for fastening the mounting plate 11 directly to an interior surface S of the vehicle, the suction cup mounting platform 1 becomes a permanent suction cup mounting platform within the vehicle.

While the preferred and additional alternative embodiments of the invention have been illustrated and described, it will be appreciated that various changes can be made therein without departing from the spirit and scope of the invention Therefore, it will be appreciated that various changes can be made therein without departing from the spirit and scope of the invention. Accordingly, the inventor makes the following claims.

What is claimed is:

1. A suction cup mounting platform, the mounting platform comprising:
a substantially rigid plate having first and second opposing faces;
a suction cup mounting surface formed on the first face; and
a connector interface formed adjacent to the second face.

2. The mounting platform of claim 1 wherein the connector interface further comprises a plurality of fastener receptors arranged in a pattern compatible with a standard AMPS hole pattern.

3. The mounting platform of claim 2 wherein the plurality of fastener receptors further comprises a plurality of fastener receptors holes.

4. The mounting platform of claim 3 wherein the plurality of fastener receptors further comprises a plurality of raised bosses projected from the second face, each of the raised bosses being formed with one of the plurality of fastener receptors holes.

5. The mounting platform of claim 4, further comprising an integral stiffener structure adjacent to the second face.

6. The mounting platform of claim 4, further comprising a plurality of fasteners each sized to threadedly mate with one of the plurality of fastener receptors.

7. The mounting platform of claim 6 wherein the plurality of fastener receptors holes further comprises a plurality of internally threaded bores, and the plurality of fasteners further comprises a plurality of fasteners each having a thread matched to the internally threaded bores thereof

8. The mounting platform of claim 6 wherein the plurality of fastener receptors holes further comprises a plurality of substantially smooth internal bores, and the plurality of fasteners further comprises a plurality of self-tapping fasteners.

9. The mounting platform of claim 2 wherein the suction cup mounting surface further comprises a substantially smooth and planar surface formed on at least a portion of the first face of the plate.

10. A suction cup mounting platform, the mounting platform comprising:
a substantially rigid monolithic plate having first and second opposing faces;
a substantially smooth and planar surface formed on the first face; and
a fastening means for fastening to a predetermined hole pattern, the fastening means being formed adjacent to the second face.

11. The mounting platform of claim 10 wherein the fastening means further comprises fastening means structured to be substantially compatible with a first predetermined standard AMPS hole pattern.

12. The mounting platform of claim 11 wherein the fastening means further comprises a plurality of fastener receptors arranged in a pattern compatible with a standard AMPS hole pattern.

13. The mounting platform of claim 12 wherein the plurality of fastener receptors further comprises a plurality of raised bosses integrally projected from the second face, each of the raised bosses being formed with a fastener receptor hole.

14. The mounting platform of claim 13, further comprising weighted mounting platform comprising a body structure forming a central hub structured with a predetermined hole pattern substantially compatible with the fastening means and having a plurality of legs projecting therefrom and an enlarged mass positioned adjacent to an end portion of one or more of the legs distal from the hub, at least a portion of the body structure being substantially covered with a flexible elastomeric skin.

15. The mounting platform of claim 13, further comprising an accessory vehicle mounting platform structured with a first predetermined standard AMPS hole pattern spaced apart from a second predetermined hole pattern substantially compatible with existing dash fittings of a specific vehicle.

16. A method for providing mounting of a suction cup in a vehicle, the method comprising:
within an interior of a vehicle, providing an accessory vehicle mounting platform comprising a first predetermined hole pattern substantially exposed relative to an interior portion of the vehicle;
providing a monolithic plate having first and second opposing faces, the first face comprising a suction cup mounting surface formed thereon; and
connecting the second face of the monolithic plate to a portion of the accessory vehicle mounting platform with the first face thereof facing away therefrom.

17. The method of claim 16 wherein the providing a monolithic plate further comprises injection molding the monolithic plate of an injection moldable material, including injection molding the suction cup mounting surface as a substantially smooth and planar surface formed on the first face thereof

18. The method of claim 17 wherein the providing a monolithic plate further comprises forming a plurality of fastener receptors on the second face thereof in a pattern substantially compatible with a first predetermined standard AMPS hole pattern;
wherein the providing an accessory vehicle mounting platform comprising a first predetermined hole pattern further comprises:
providing an accessory vehicle mounting platform structured with a second predetermined hole pattern spaced apart from the first predetermined standard AMPS hole pattern and being substantially compatible with existing fittings of a dash of the vehicle, and
connecting the second predetermined hole pattern of the accessory vehicle mounting platform to the dash of the vehicle with existing fittings thereof; and
wherein the connecting the second face of the monolithic plate to the mounting platform further comprises:
substantially aligning the plurality of fastener receptors of the monolithic plate with the first predetermined standard AMPS hole pattern of the accessory vehicle mounting platform, and
threading a plurality of fasteners between the first predetermined standard AMPS hole pattern of the accessory vehicle mounting platform and the fastener receptors of the monolithic plate for securing the monolithic plate to the accessory vehicle mounting platform.

19. The method of claim 18 wherein the forming a plurality of fastener receptors further comprises forming a plurality of substantially smooth internal bores adjacent to the second face of the monolithic plate; and
wherein the threading a plurality of fasteners between the first predetermined standard AMPS hole pattern of the accessory vehicle mounting platform and the fastener receptors of the monolithic plate further comprises tapping one of a plurality of self-tapping fasteners into one or more of the internal bores of the plurality of fastener receptors.

20. The method of claim 17 wherein the connecting the second face of the monolithic plate to a portion of the accessory vehicle mounting platform further comprises substantially permanently bonding the second face of the monolithic plate to a portion of the accessory vehicle mounting platform with an adhesive pad therebetween.
